(19) United States
(12) Patent Application Publication
(10) Pub. No.: US 2009/0122413 A1
(43) Pub. Date: May 14, 2009

(54) SYSTEMS AND METHODS FOR AIDING SITUATIONAL AWARENESS

(76) Inventors: Joe Hoffman, Phoenix, AZ (US); David C. Huffman, Norcross, GA (US); Philip A. Moylan, Portland, OR (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/039,561

(22) Filed: Feb. 28, 2008

Related U.S. Application Data
(60) Provisional application No. 60/904,356, filed on Feb. 28, 2007.

(51) Int. Cl. G02B 27/01

(52) U.S. Cl. 359/630

(57) ABSTRACT

A method for displaying an image according to one embodiment of the present invention includes projecting an image away from a first display surface and a second display surface onto a reflective surface, and orienting the reflective surface to selectively redirect the image onto either the first display surface or the second display surface.

### CROSS-REFERENCE TO RELATED APPLICATION

This application claims priority to U.S. Provisional Patent Application Ser. No. 60/904,356 filed Feb. 28, 2007, the disclosure of which is incorporated by reference in its entirety.

### DESCRIPTION OF THE INVENTION

1. Field of the Invention

The present invention relates to systems and methods for aiding pilot situational awareness, and more particularly, to aiding pilot situational awareness through the use of a heads up display.

2. Background of the Invention

Heads up displays (HUDs) are used in a variety of aircraft and other vehicles to display information without obstructing a user's view through the windows of a vehicle. HUDs enhance a vehicle operator's situational awareness by providing the operator information without forcing him/her to look down at an instrument panel. In aircraft, HUDs can be used to enhance the situational awareness of pilots and co-pilots in a variety of situations, including takeoffs, landings, and periods of reduced-visibility. This enhanced situational awareness can help avoid collisions between aircraft and other accidents.

Conventional HUD systems in aircraft cockpits generally include a projector that projects an image containing various information onto a display known as a combiner glass. A combiner glass can be partially transparent, and may include a coating configured to reflect the image from the projector back to a user while allowing the user to still see through the combiner glass (and out the window of the cockpit). In many conventional HUD systems, the projector must be located directly above a pilot or co-pilot's head in the cockpit so that the projector is centered in front of the combiner glass in order to project an undistorted image onto the combiner glass.

However, the configuration and space constraints in some cockpits may prohibit the location of a projector directly in front of a combiner glass display. The challenge of providing two separate projectors to provide a separate HUD for the pilot and copilot can be even more difficult. Many conventional projectors are unsuited to be positioned in alternate locations, since placing such projectors “off-axis,” (or away from the front of the combiner display) can lead to an unacceptable level of distortion on the display. Embodiments of the present invention address these and other issues.

### SUMMARY OF THE INVENTION

Embodiments of the present invention can improve a pilot's level of situational awareness by enabling the implementation of HUD systems in cockpits that would ordinarily be unable to accommodate such systems. Embodiments of the present invention provide smaller, more versatile and cost-effective solutions for HUD systems.

One method for displaying an image according to one embodiment of the present invention includes projecting an image away from a first display surface and a second display surface onto a reflective surface, and orienting the reflective surface to selectively redirect the image onto either the first display surface or the second display surface.

A front projection display system according to another embodiment of the present invention comprises a first display surface, a second display surface distinct from the first display surface, a projector configured to project an image away from the first display surface and the second display surface, and a reflective surface that may be oriented to selectively reflect the image onto either the first display surface or the second display surface.

A method for displaying information in a cockpit of an aircraft according to another embodiment of the present invention includes providing a projector in front of a pair of heads up displays mounted in the cockpit and selectively orienting the projector to project an image onto a desired one of the heads up displays.

A system for displaying an image in a cockpit of an aircraft according to another embodiment of the present invention comprises a first heads up display, a second heads up display, a projector located in front of the first heads up display and second heads up display that may be oriented to selectively project the image onto a desired one of the heads up displays.

Both the foregoing summary and the following detailed description are exemplary and explanatory only and are not restrictive of the invention.

### BRIEF DESCRIPTION OF THE DRAWINGS

A more complete understanding of the present invention may be derived by referring to the detailed description and claims when considered in connection with the following illustrative figures.

FIGS. 1A and 1B are plan views illustrating an exemplary system according to various aspects of the present invention.

FIGS. 2A and 2B are plan views illustrating another exemplary system according to various aspects of the present invention.

FIG. 3 is a flow diagram depicting an exemplary method according to various aspects of the present invention.

### DETAILED DESCRIPTION OF EXEMPLARY EMBODIMENTS

### Exemplary Systems

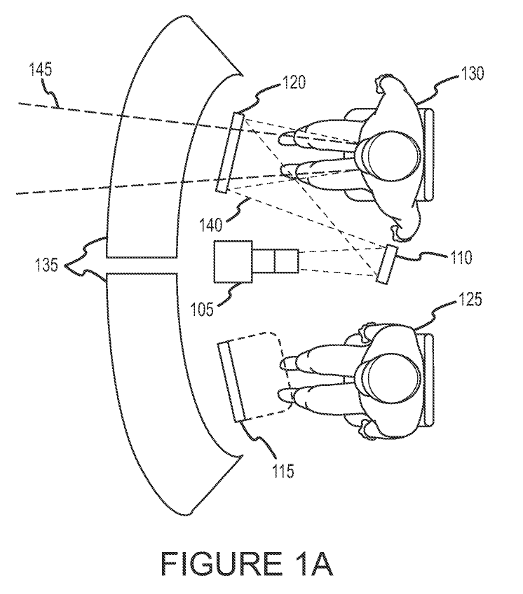

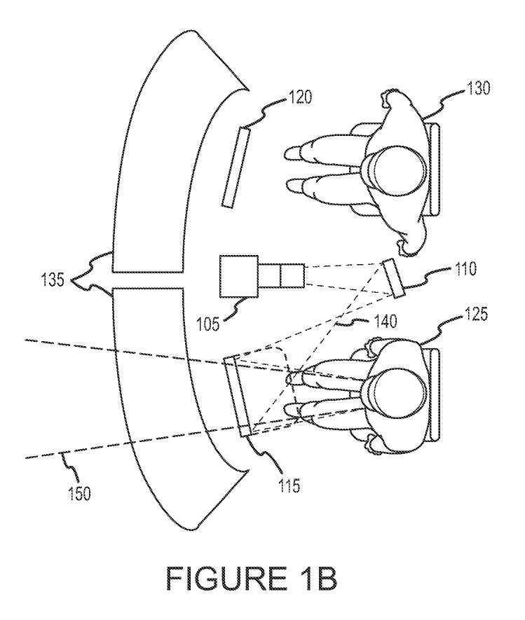

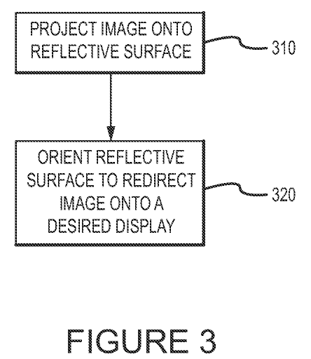

An exemplary system according to aspects of the present invention is depicted in FIGS. 1A and 1B. This system may be used in conjunction with the method depicted in FIG. 3. The system shown in FIGS. 1A and 1B may also be used in conjunction with any other suitable embodiments of systems and methods operating in accordance with the present invention. In FIGS. 1A and 1B, a projector 105 projects an image 140 away from combiner glass displays 115 and 120 and onto a reflector 110. The reflector 110 can be oriented to redirect the image 140 onto the combiner glass display 120 for the co-pilot 130 (as shown in FIG. 1A) or the combiner glass display 115 for the pilot 125 (as shown in FIG. 1B) or. The pilot 125 and co-pilot 130 are thus able to alternately view the projected image 140, while maintaining a field of view 145, 150 out of the canopy 135 of the cockpit. The exemplary embodiment of the present invention depicted in FIGS. 1A and 1B allows the projector 105 to be placed nearer to the front of a cockpit that would otherwise not be able to accommodate projectors mounted above the heads of the pilot 125 and co-pilot 130, and may use one projector 105 to alternately project the image 140 on the combiner display 115 for the pilot 125 or the combiner display 120 for the co-pilot 130. If desired, two or more projectors 105 may be employed in proximity to the front of the cockpit, each dedicated to a respective combiner glass display 115, 120.

In the exemplary embodiment depicted in FIGS. 1A and 1B, the projector 105 is a front projector mounted in proximity to the forward portion of the cockpit. The projector 105 faces away from both of the combiner glass displays 115, 120 and projects the image 140 onto the reflector 110. The projector 105 may be any system or device capable of projecting an image, either by itself or in conjunction with any number of other systems and devices. The projector 105 may be of any size, shape, and configuration and may be selected for use with the present invention according to any desired criteria. For example, in one embodiment of the present invention, the projector 105 may be a miniaturized projector, such as the projectors described in U.S. Pat. No. 5,416,876 to Ansley et al., U.S. Pat. No. 5,726,671 to Ansley et al., U.S. Pat. No. 5,822,127 to Chen et al., and/or U.S. Pat. No. 5,835,277 to Hegg, each of which are incorporated herein by reference in their entirety.

The projector 105 may include (or interface with) software and/or hardware for correcting and/or compensating for distortion of the image 140 so that the image 140 appears properly on the combiner glass displays 115, 120. Such distortion correction may be necessary to correct for, among other things, the redirection of the image from the projector 105 to the displays 115, 120 by the reflector 110, movement/vibration of the aircraft, and/or the positioning of the reflector 110 relative to the displays 115, 120 (i.e.—not centered in front of the displays 115, 120). A more detailed description of exemplary distortion correction systems and methods that may be used in conjunction with the present invention may be found in U.S. Pat. No. 5,748,264 to Hegg and U.S. Pat. No. 5,414,521 to Ansley, each of which are incorporated herein by reference in their entirety.

The projector 105 may include, or operate in conjunction with, any number of other systems and devices. For example, the projector 105 may be coupled with a projection drive system (not shown) located separately from the projector 105 and that generates the image and provides it to the projector 105 (through a fiber optic interface, for example). This configuration may allow the projector 105 to be smaller and lighter, and thus able to fit in portions of the cockpit a larger projector (that is integrated with the projection drive system) could not. The projector 105 may operate in conjunction with any other desired system or device.

The reflector 110 may comprise any suitable structures, systems, and devices to redirect the image 140 from the projector 105 to the displays 115, 120. The reflector 110 may include any number of reflective surfaces of any suitable size, shape, symmetry, and/or configuration. In one exemplary embodiment, the reflector 110 comprises a mirror. The reflector 110 may also be integrated with, or operate in conjunction with, any other desired systems and devices. For example, in one embodiment, the reflector 110 may be coupled to a processor and memory (both not shown) to control the orientation of the reflector 110. In this embodiment, the memory stores instructions to cause the processor to orient the reflector 110 (e.g. by controlling an actuator coupled to the reflector 110) to selectively redirect the image 140 to either the combiner glass display 115 for the pilot 125 or the combiner glass display 120 for the co-pilot 130.

The processor may retrieve and process any type of data and instructions from the memory. Any number and type of processor(s) such as an integrated circuit microprocessor, microcontroller, and/or digital signal processor (DSP), can be used in conjunction with the present invention. The processor may interface and/or control any other desired components. The memory may store instructions, data, and/or any other suitable information for use by the processor, as well as other systems and devices operating in conjunction with systems and methods of the present invention. The memory may include any combination of different memory storage devices and computer-readable media, such as hard drives, tape drives, random access memory (RAM), read only memory (ROM), FLASH memory, compact discs, optical discs, and/or any other type of volatile and/or nonvolatile memory. Any number of memory storage devices of any size and configuration may also be used in conjunction with the present invention. The processor and/or memory may be included in a computer system dedicated to controlling the reflector 110, or may be part of a computer system configured to control or interface with other systems and devices, such as the projector 105.

The reflector 110, or individual reflective surfaces thereof, may be oriented in any desired manner. For example, any combination of the reflector's lateral, vertical, and axial position may be altered in order to redirect the image 140 from the projector 105 to a desired display 115, 120. The reflector 110 may include, or be coupled to, any number of actuating systems to control its orientation. The reflector 110 may have any desired characteristics. For example, reflective surfaces in a reflector 110 may be of any size, shape, and/or symmetry. The reflector 110 may comprise any number of separate reflective surfaces, and such reflective surfaces may exhibit any desired characteristics, such as partial transparency. Multiple reflective surfaces may be employed, for example, to simultaneously redirect the image 140 to different displays.

The reflector 110 may be configured to modify and/or process the image 140 from the projector 105 in any desired manner. For example, the reflector 110 may be configured to correct for distortion and/or error in the image 140 so that the image 140 can be displayed on the combiner glasses 115, 120 properly. The reflector 110 may also magnify or shrink a portion of the image 140.

Combiner glass displays 115, 120 display the image 140 while allowing the pilot 125 or co-pilot 130 to maintain a field of vision 150, 145 through the canopy 135 of the cockpit. Any other suitable type of display of any desired configuration may operate in conjunction with the present invention. For example, a display may comprise organic light-emitting devices (OLEDs) and/or transparent OLED (TOLED) displays. Any desired characteristic of a display operating in conjunction with the present invention, such as the level of transparency of the display, may be configurable.

An exemplary method according to various aspects of the present invention is depicted in FIG. 3. This method may be implemented in any desired manner, such as through software operating on a computer system coupled to systems and devices of the present invention. The elements of this method, as with any method in accordance with the present invention, may be practiced in any suitable order and in conjunction with any other desired methods, in whole or in part.

FIG. 3 depicts an exemplary method that may be practiced in conjunction with the system depicted in FIGS. 1A and 1B. In this method, an image is projected onto a reflective surface (310), such as a reflective surface included in reflector 110 as discussed previously. The reflective surface is oriented to redirect the image onto a desired display (320), such as either the pilot's combiner glass display 115 or the co-pilot's combiner glass display 120 depicted in FIGS. 1A and 1B.

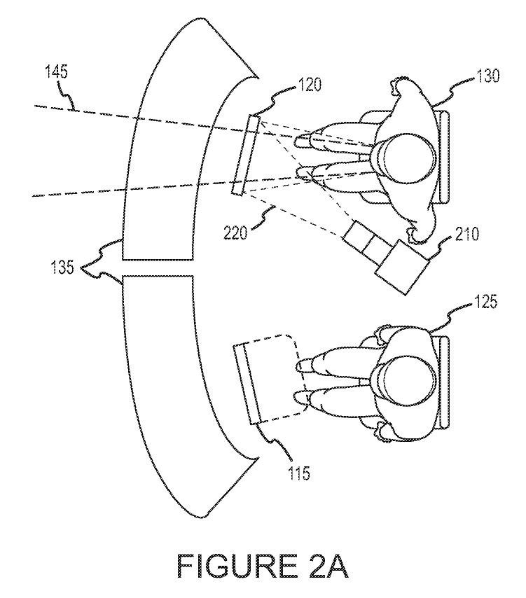

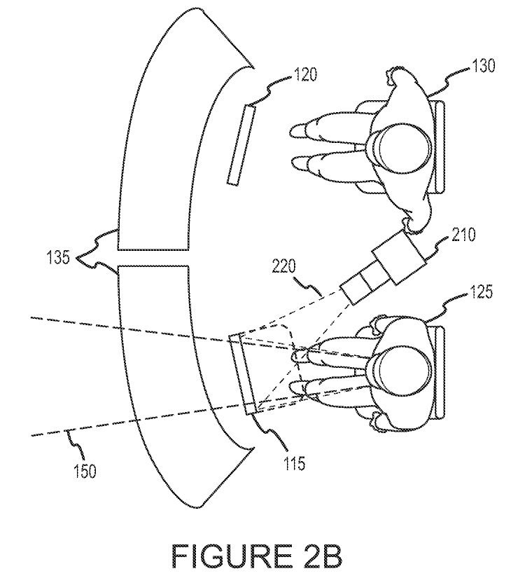

FIGS. 2A and 2B depict another exemplary embodiment of the present invention. In the operation of this embodiment, the projector 210 can be oriented (e.g. swiveled) to selectively project an image 220 onto either the pilot's combiner glass display 115 or the co-pilot's combiner glass display 120. The orientation of the projector 210 may be effected in any desired manner, such as by a processor executing instructions stored in a memory device to control an actuation system coupled to the projector 210. The projector 210 can be mounted off-angle from either or both the combiner glass display 115 or the combiner glass display 120, allowing the projector 210 to be more easily located in a crowded aircraft cockpit.

Any combination and/or subset of the elements of the methods of the present invention may be practiced in any suitable order and in conjunction with any system, device, and/or process. The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method for displaying an image comprising:
projecting an image away from a first display surface and a second display surface onto a reflective surface; and
orienting the reflective surface to selectively redirect the image onto either the first display surface or the second display surface.

2. The method of claim 1, further comprising altering the image from the projector to compensate for distortion.

3. A front projection display system comprising:
a first display surface;
a second display surface distinct from the first display surface;
a projector configured to project an image away from the first display surface and the second display surface; and
a reflective surface that may be oriented to selectively reflect the image onto either the first display surface or the second display surface.

4. The system of claim 3, wherein the first and second display surfaces are portions of a single combiner glass.

5. The system of claim 3, wherein the first and second display surfaces are on separate combiner glasses.

6. The system of claim 3, wherein the first and second display surfaces are least partially transparent.

7. The system of claim 3, further comprising:
a processor; and
a memory in communication with the processor and storing instructions that, when executed by the processor, cause the processor to control the orientation of the reflector.

8. A method for displaying information in a cockpit of an aircraft, the method comprising:
providing a projector in front of a pair of heads up displays mounted in the cockpit; and
selectively orienting the projector to project an image onto a desired one of the heads up displays.

9. The method of claim 8, further comprising altering the image from the projector to compensate for distortion.

10. A system for displaying an image in a cockpit of an aircraft, the system comprising:
a first heads up display;
a second heads up display;
a projector located in front of the first heads up display and the second heads up display that may be oriented to selectively project the image onto a desired one of the heads up displays.

11. The system of claim 10, wherein the first heads up display and second heads up display are portions of a single combiner glass.

12. The system of claim 10, wherein the first heads up display and second heads up display comprise separate combiner glasses.

13. The system of claim 10, wherein the first heads up display and second heads up display are least partially transparent.

14. The system of claim 10, further comprising:
a processor; and
a memory in communication with the processor and storing instructions that, when executed by the processor, cause the processor to control the orientation of the projector.
